(19) United States
(12) Patent Application Publication
(10) Pub. No.: US 2026/0340407 A1
(43) Pub. Date: Oct. 29, 2026

(54) AGENTIC WORKFLOW CREATION AND EXECUTION WITH VERIFICATION AND DYNAMIC REGISTRY MANAGEMENT

(71) Applicant: Cisco Technology, Inc., San Jose, CA (US)

(72) Inventors: Saurabh Gupta, Bellevue, WA (US); Andrea Morandi, Greenbrae, CA (US)

(73) Assignee: Cisco Technology, Inc., San Jose, CA (US)

(21) Appl. No.: 19/286,590

(22) Filed: Jul. 31, 2025

Related U.S. Application Data
(60) Provisional application No. 63/793,199, filed on Apr. 23, 2025.

(51) Int. Cl. G06N 3/092

(52) U.S. Cl. CPC G06N 3/092

(57) ABSTRACT

In some implementations, a device assigns sub-tasks to a plurality of artificial intelligence-based agents in a multi-agent system to complete a task, based on information indicative of their capabilities stored in an agent directory. The device makes a determination that a particular agent from among the plurality of artificial intelligence-based agents is unable to perform its assigned sub-task based on telemetry data regarding performance of the sub-tasks by the plurality of artificial intelligence-based agents. The device re-assigning, based on the determination, a sub-task from the particular agent to another agent in the multi-agent system during completion of the task. The device updates the information in the agent directory to reflect the determination.

### RELATED APPLICATION

The present disclosure claims priority to U.S. Prov. Appl. Ser. No. 63/793,199, filed on Apr. 23, 2025, entitled “AGENTIC WORKFLOW CREATION AND EXECUTION WITH VERIFICATION AND DYNAMIC REGISTRY MANAGEMENT,” by Gupta, et al., the contents of which are incorporated herein by reference.

### TECHNICAL FIELD

The present disclosure relates generally to wireless communications and, more particularly, to agentic workflow creation and execution with verification and dynamic registry management.

### BACKGROUND

The recent breakthroughs in large language models (LLMs) and other generative artificial intelligence (AI) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more generative AI models. Agentic systems take this even one step further, with multiple agents that are possibly tied to different AI models coordinating with one another to complete tasks.

However, implementing multi-agent systems still remains challenging to ensure that each agent correctly performs its assigned task in an optimal way. In addition, it can be challenging to maintain an accurate and up-to-date registry of available agents, their capabilities, and performance metrics. Further, it can be difficult to automate workflow generation and execution in a distributed and heterogeneous environment, as well as to optimize those workflows for specific use-case goals and technical efficiency.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example architecture for automatically generating workflows for AI agents; and

FIG. 6 illustrates an example simplified procedure for automatically generating workflows for AI agents, in accordance with one or more implementations described herein.

### DESCRIPTION OF EXAMPLE IMPLEMENTATIONS

### Overview

According to one or more implementations of the disclosure, a device assigns sub-tasks to a plurality of artificial intelligence-based agents in a multi-agent system to complete a task, based on information indicative of their capabilities stored in an agent directory. The device makes a determination that a particular agent from among the plurality of artificial intelligence-based agents is unable to perform its assigned sub-task based on telemetry data regarding performance of the sub-tasks by the plurality of artificial intelligence-based agents. The device re-assigning, based on the determination, a sub-task from the particular agent to another agent in the multi-agent system during completion of the task. The device updates the information in the agent directory to reflect the determination.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

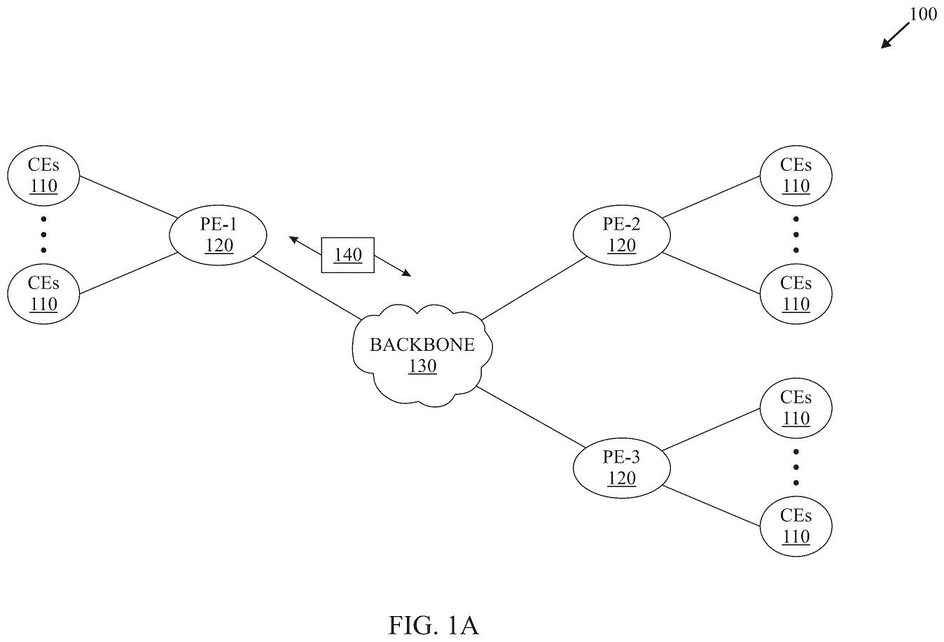

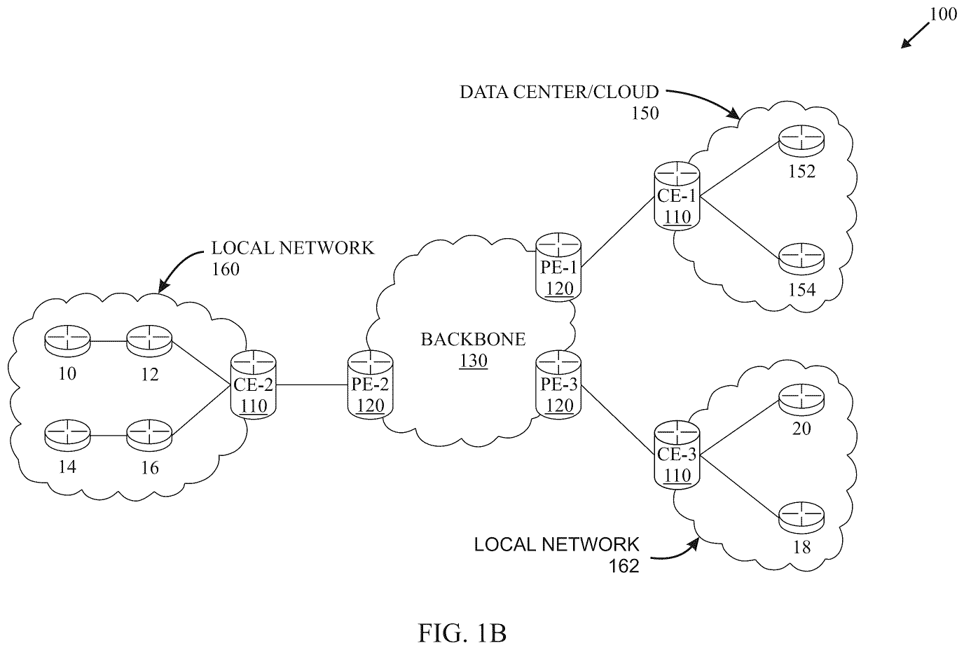

FIG. 1A is a schematic block diagram of an example network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router connected to PE-2 and a second CE router connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

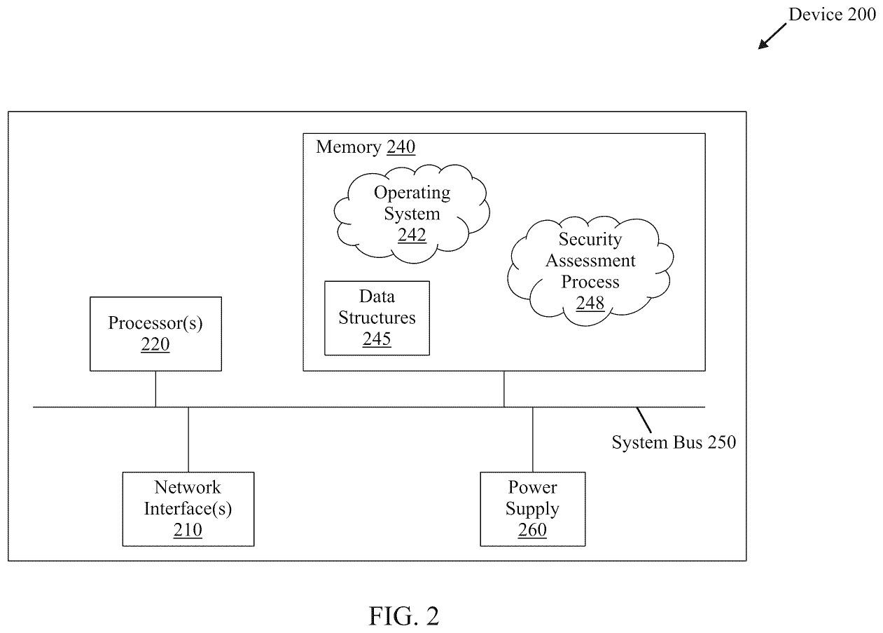

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s), such as network 100. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize artificial intelligence (AI)/machine learning (ML). In general, AI/ML is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, Mis a statistical model, and the cost function is inversely proportional to the likelihood of M, given the input data.

In various implementations, AI process 248 may leverage one or more supervised, unsupervised, or semi-supervised AI/ML models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/ML techniques that the AI process 248 may employ include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use, one or more generative AI/ML models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

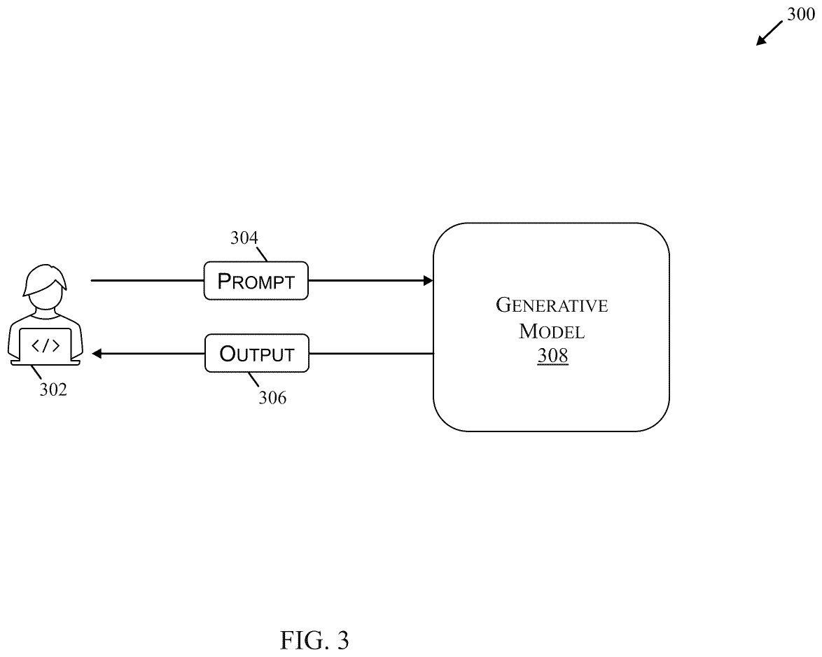

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

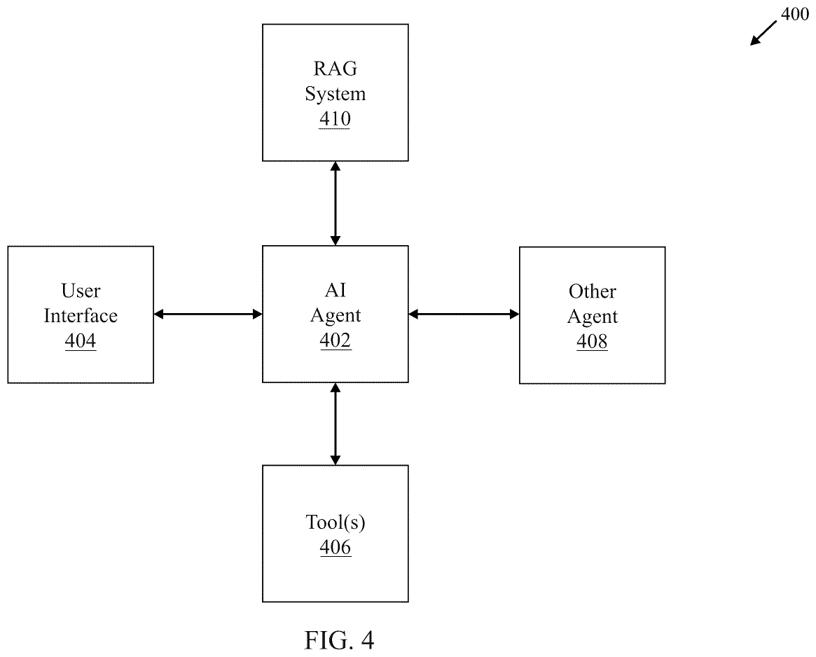

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, implementing such agentic systems can be challenging for reasons such as:
1. Ensuring that each agent correctly performs its assigned task in an optimal way
2. Maintaining an accurate and up-to-date registry of available agents, their capabilities, and performance metrics
3. Automating workflow generation and execution in a distributed and heterogeneous environment, and workflows optimization for specific business goals as well as technical efficiency.
   ——Agentic Workflow Creation and Execution with Verification and Dynamic Registry Management——

The techniques herein introduce e a comprehensive system for automatic workflow generation with built-in verification mechanisms and dynamic registry management.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device assigns sub-tasks to a plurality of artificial intelligence-based agents in a multi-agent system to complete a task, based on information indicative of their capabilities stored in an agent directory. The device makes a determination that a particular agent from among the plurality of artificial intelligence-based agents is unable to perform its assigned sub-task based on telemetry data regarding performance of the sub-tasks by the plurality of artificial intelligence-based agents. The device re-assigning, based on the determination, a sub-task from the particular agent to another agent in the multi-agent system during completion of the task. The device updates the information in the agent directory to reflect the determination.

Operationally, the techniques herein introduce a comprehensive system for automatic workflow generation and execution in an Internet of Agents (IoA)/Multi-Agent System (MAS) ecosystem, with mechanisms for ensuring correct task execution and maintaining an up-to-date agent registry. In some aspects, the system allows agents to discover each other, establish secure communication channels, and collaborate on complex tasks through standardized protocols, while incorporating advanced verification and dynamic registry management capabilities.

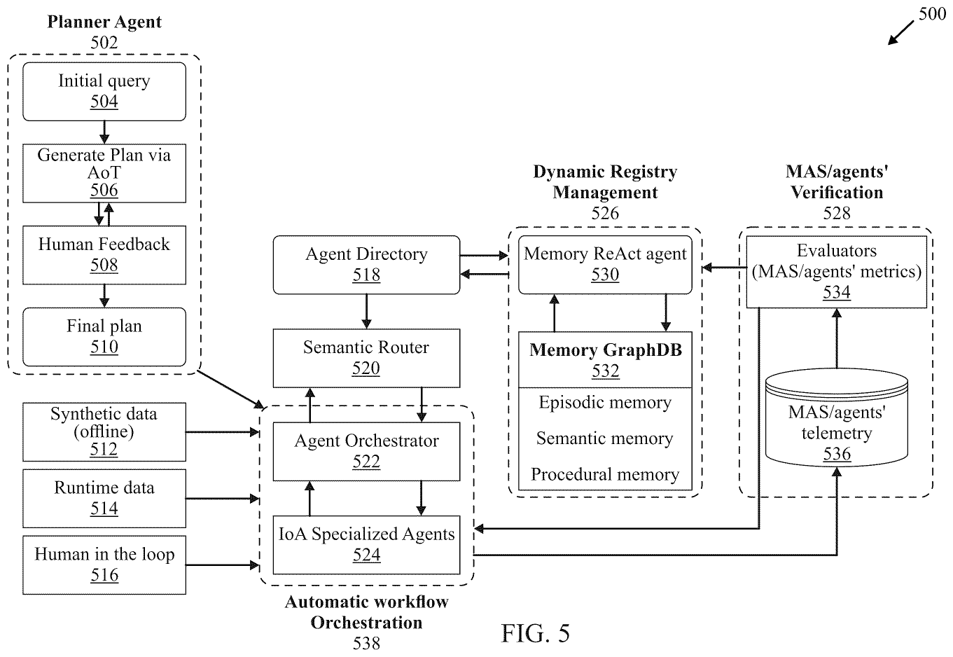

According to various implementations, the overall IoA/MAS ecosystem may include any or all of the following components (e.g., components of AI process 248), as shown in architecture 500 in FIG. 5:
Planner agent 502 responsible for generating an execution plan for the selected agent(s) to complete a specified task. Further implementations provide for the functions of planner agent 502 to be performed by a plurality of such agents and/or the functionality of planner agent 502 integrated into any of the other components of planner agent 502 described below.
Automatic workflow orchestration framework 538: this component may be responsible for decomposing high-level goals into tasks, generating workflows, and/or coordinating their execution.
Dynamic registry management framework 526: this component may maintain up-to-date information about available agents, their capabilities, and/or performance metrics through a memory-enhanced agent, such as a ReAct agent 530, as detailed below.
Verification framework 528: this component ensures correct task execution through specialized evaluators at both single-agent and multi-agent system (MAS) levels.

In some implementations, architecture 500 may also leverage any or all of the following:
A specialized communication protocol: such a protocol provides secure and efficient communication between agents.
A monitoring and adaptation mechanism: this may allow architecture 500 to track workflow execution, detects issues, and/or adapts workflows as needed.
A security layer: such a layer may ensure that all agent interactions are secure and authenticated.

More specifically, as shown in FIG. 5, a user, agent, or other source may issue an initial query 504 that is used as input to planner agent 502. In general, initial query 504 may outline both the overall task goal for the MAS and specify any processing objectives (e.g., speed, cost-efficiency, security, compliance). In turn, planner agent 502 may decomposes this into atomic tasks (e.g., sub-tasks) to generate a plan, at block 506. For instance, planner agent 502 may apply Atom of Thought (AoT) reasoning or Chain of Thought (CoT) reasoning, to devise the steps that the MAS should perform, to complete the task goal specified via initial query 504.

In one implementation, planner agent 502 may also seek human feedback 508, such as via a user interface, regarding its plan formulated at block 506. Doing so allows the user to revise, cancel, or accept the proposed plan. Based on human feedback 508, planner agent 502 may then formulate final plan 510 for processing by agent orchestrator 522 in automatic workflow orchestration framework 538.

In some implementations, agent orchestrator 522 may use semantic router 520 and agent directory 518 (e.g., a repository for agent manifests) to dynamically select the appropriate agents from among IoA specialized agents 524 to execute final plan 510 based on their capabilities and metrics. The result is an execution workflow graph that controls the flow of execution of the selected agents and in alignment with the defined goals.

To ensure the efficacy of the task execution, verification framework 528 may include one or more evaluators 534 that assess the captured telemetry 536 from the MAS/agents during their performance of their assigned sub-tasks. For instance, captured telemetry 536 may include, but not limited to, data such as the input and/or output data from a given agent, any errors encountered by the agent during its performance of the sub-task, latency or other performance metrics, inter-agent communication metrics, or the like.

In some instances, one or more evaluators 534 may leverage one or more LLM-as-a-judge models, that may provide feedback to a memory ReAct agent 530 that is part of dynamic registry management framework 526. As would be appreciated, a ReAct (reasoning and acting) agent may leverage CoT or other reasoning approach to make decisions and act on them. For instance, based on captured telemetry 536, memory ReAct agent 530 may leverage memory graph database 532 to update agent directory 518, thereby dynamically influencing the selection of agents by agent orchestrator 522. As shown, ReAct agent 530 may store and retrieve data from memory graph database 532 so as to maintain an episodic, semantic, and/or procedural memory).

In some instances, human-in-the-loop oversight 516 can validate the outputs of any of the components of architecture 500, such as the selection of agents from IoA specialized agents 524 for a given task by agent orchestrator 522. Other information that may affect this agent selection and workflow execution could also include runtime data 514 and/or synthetic data 512 that could be generated offline.

In various implementations, architecture 500 may perform any or all of the following steps to generate a task workflow for execution by the selected agents:
1. Goal Analysis: planner agent 502 analyzes the high-level goal to understand requirements and constraints specified by initial query 504.
2. Task Decomposition: planner agent 502 may leverage the AoT approach at block 506 to decompose the goal into smaller “atoms” or steps that can be executed by individual agents, such as based on business objectives and metrics optimization.
3. Agent Selection: for each task, agent orchestrator 522 selects the appropriate agents from among IoA specialized agents 524 based on their capabilities, availability, and performance history, utilizing semantic router 520 and the agent manifests stored in agent directory 518.
4. Workflow Construction: agent orchestrator 522 also constructs a workflow graph that defines the sequence and dependencies between sub-tasks.
5. Resource Allocation: agent orchestrator 522 may also allocate resources to each task based on its requirements and priority, as well as business constraints (e.g. cost).

In various implementations, the workflow execution may then proceed as follows:
1. Task Initialization: each selected agent may be initialized with the necessary context/parameters.
2. Task Execution: the agents execute their assigned tasks, communicating with other agents as needed.
3. Verification: architecture 500 verifies the correctness of each task execution using the one or more evaluators 534.
4. Progress Monitoring: architecture 500 may also monitor the progress of each task and the overall workflow.
5. Result Aggregation: architecture 500 may aggregate the results from the individual sub-tasks to produce the final output.
6. Adaptation: if issues arise during execution, architecture 500 may also adapt the workflow accordingly. To do so, the one or more evaluators 534 may notify agent orchestrator 522 of any issues during execution of the workflow, to reassign a sub-task to another agent or take other corrective measures in real time.

Indeed, an important aspect herein is the ability of the system to ensure that the agents correctly perform their workflow tasks. To do so, architecture 500 may leverage any or all of the following:
1. Synthetic Data Generation: the system may use a Language Agent Tree Search (LATS) approach to generate high-quality, synthetic data 512 for offline evaluation of agents.
2. Multi-Level Evaluation: in some implementations, architecture 500 may perform its evaluation two levels:
   MAS-level evaluation: architecture 500 assesses the overall performance of the multi-agent system, as detailed below
   Agent-level evaluation: architecture 500 evaluates individual agent performance
3. Specialized Metrics: the system may employ both predefined and custom metrics which may include any or all of the following:
   MAS-level metrics: Cross-Component Utilization Rate, Workflow Cohesion Index, Component Conflict Rate, Component Synergy Score, and Downstream quality metrics and other specialized metrics.
   Agent-level metrics: Task-Specific Rubrics, Performance Consistency, Error Detection Rate, and other specialized metrics.
4. LLM-as-a-Judge: converts unstructured telemetry into structured metrics that can be used for evaluation and adaptation.
5. Feedback Loop: evaluation results are fed back to agent orchestrator 522 to improve its agent selection and workflow optimization.

In various implementations, the system may also implement comprehensive metrics (e.g., captured telemetry 536) for evaluating the overall performance of the MAS, in particular with respect to the workflow orchestration quality. Such metrics may include any or all of the following:
1. Cross-Component Utilization Rate: Measures how effectively information or outputs from one component are used by another.
2. Workflow Cohesion Index: Assesses the seamless integration among components.
3. Component Conflict Rate: Tracks the frequency of conflicts or inconsistencies between different components.
4. Component Synergy Score (CSS): Calculated as: CSS=(Cross-Component Utilization Rate*Workflow Cohesion Index)/(1+Component Conflict Rate
5. Downstream (e.g. final response) quality metrics

By way of example, Table 1 below shows examples of MAS-level metrics that the system may assess, with a numerical score (on a scale of 1-10) and a “Feedback” field (that is the justification behind the assigned score for each specific metric). Scores and feedback are obtained via an LLM-as-a-judge model:

TABLE 1

| Rubric | Score | Feedback |
|---|---|---|
| Groundedness | 9.85 | The generated code is based on verifiable information, directly |
| | | relevant to the query, and avoids speculative content. This |
| | | ensures that the code is factually accurate and pertinent. The |
| | | code is often noted to be efficient and optimized, which is |
| | | crucial for performance, especially in computationally |
| | | intensive tasks. The code generally adheres to PEP 8 |
| | | guidelines, which is important for maintaining a standard |
| | | coding style and improving readability. |
| Relevance | 9.96 | The code could benefit from more specific error messages, |
| | | which would help in better understanding the nature of errors |
| | | when they occur. The critique suggest that the logging could |
| | | be improved by incorporating more granular levels such as |
| | | info., warning, and error, which would enhance the debugging |
| | | process and provide clearer insights into the code's execution |
| | | flow. |
| Component | 7.42 | Despite the conversations being clear and consistent, the low |
| Conflict Rate | | score suggest that the performance metric is not solely based |
| | | on clarity and consistency. The calculation on the Component |
| | | Conflict Rate as 0 indicates that there might be other factors |
| | | affecting the score, such as the number of data exchanges or |
| | | the complexity of the task. |
| Workflow | 9.54 | The conversations are clear and well-structured, and the |
| Cohesion | | Orchestrator incorporates feedback effectively. There are no |
| Index | | inconsistencies or errors detected. However, the score of 0 |
| | | suggests that there might be underlying issues not captured in |
| | | the reasoning provided, possibly related to the overall |
| | | effectiveness or efficiency of the solution. |
| Cross- | 8.54 | The main issue is that the assistant does not effectively utilize |
| Component | | the outputs from one component to another. While the |
| Utilization | | assistant generates and evaluates code, it does not leverage the |
| Rate | | feedback or results from one tool to improve or progress the |
| | | task using another tool. The workflow appears to be |
| | | disjointed, with components working in isolation rather than |
| | | collaboratively. |

In some implementations, the system may also assess agent-level evaluation metrics as well. For instance, for individual agents, the system may consider specialized evaluation metrics such as:
1. Task-Specific Rubrics: Customized evaluation criteria for different types of tasks (e.g., code generation quality, text analysis).
2. Performance Consistency: Measures how consistently an agent performs across different instances of similar tasks.
3. Error Detection Rate: Tracks how effectively an agent identifies errors e.g. in using tools and passing parameters to API calls.

Table 2 below illustrates an example of agent-level metrics:

TABLE 2

| Metric Name | Metric Definition |
|---|---|
| Intent | Measures how well the MAA understands and correctly identifies |
| Recognition | user intents. |
| Accuracy | |
| Tool Utilization | Measures the MAA's ability to select and use appropriate tools |
| Accuracy | effectively. Does not take into account ordering of tools and does |
| | not take into account parameters passed. |
| Tool Usage | Measures whether the tool is called in the right order relative to |
| Order | other tools. |
| Tool Error Rate | Measures error or failures during tool execution. |
| API Call | Measures the precision and correctness of the parameters passed to |
| Precision | the tool. |
| Context | Measures the MAA's ability to handle multi-turn conversations and |
| Preservation | maintain context throughout the interaction. |
| Score | |
| Information | Measures how well information is being retained by the MAA. |
| Retention | |
| Response | Measures the consistency in responses across different interactions, |
| Relevancy | an important metric to ensure that AI responses remain reliable, |
| | coherent, and aligned over time. |
| Response | Measures the latency from retrieving stored information and is best |
| Consistency | suited for applications where long-term memory retention and |
| | coherence, and aligned over time. |
| Retrieval | Measures the latency from retrieving stored information and is best |
| Latency | suited for applications where long-term memory retention and |
| | coherence in ongoing conversations are critical. |
| Error Recovery | Measures how effectively MAA recovers from failures. |
| Rate | |

By way of example, consider the use case of code generation given an instruction. Each row in the table is an agent evaluated based on custom metrics (e.g., code quality, etc.). The score is on a scale from 1-10. Scores and feedback are obtained via an LLM-as-a-judge model (e.g., one or more evaluators 534), in some implementations. Table 3 below shows such outputs:

TABLE 3

| Agent's | | |
|---|---|---|
| Evaluation | Score | Feedback |
| PEP 8 | 7.53 | The agent provides thorough evaluations but often lacks focus |
| Compliance | | on PEP 8 compliance specifically. In lower-scoring |
| | | responses, the agent evaluated other aspects like functionality, |
| | | compatibility, and security instead of addressing PEP 8 |
| | | standards. When properly focused, the agent gives accurate |
| | | and specific recommendations for PEP 8 improvements, but |
| | | this focus is inconsistent across evaluations. |
| Code Quality | 9.0 | The agent delivers thorough and accurate assessments of code |
| | | quality, covering readability, simplicity, and Pythonic |
| | | practices. While evaluations are consistently aligned with |
| | | compliance requirements, some responses lack specific |
| | | recommendations and detailed feedback that would maximize |
| | | value to code authors. The agent effectively identifies both |
| | | strengths and areas for improvements in the code. |
| Code | 8.28 | The agent provides thorough and accurate assessment of code |
| Functionality | | functionality, identifying intended purpose and edge case |
| | | handling. The structured critiques align well with compliance |
| | | requirements and offer valuable feedback for improvement. |
| | | However, some assessments lack clarity with insufficient |
| | | detailed analysis of error handling and logging mechanisms, |
| | | and don't always explicitly check for invalid inputs. |
| Performance | 7.0 | The agent thoroughly assesses performance aspects and |
| | | accurately identifies key areas where code falls short, |
| | | including efficient algorithms, optimization techniques, and |
| | | profiling tools. However, it often lacks specific |
| | | recommendations for addressing identified issues and doesn't |
| | | always consider the context of the code's use case to |
| | | determine if certain optimizations are necessary or would be |
| | | over-engineering. |

Below is an example of prompt for the Memory-Enhanced ReAct Agent:
[Abridged] You are an Intelligent agent managing long-term memory for IoA agents' interactions. Determines whether to load, store, or update Semantic, Episodic, and Procedural Memories based on such interactions.
Utilize memory tools (save IoA memory (namespace), recall IoA memory (namespace)) for this purpose.
Use the agent interaction metrics and context: {recall IoA metrics}
Instructions: Analyze the IoA agents' interaction to decide on memory operations for the specified namespace (Semantic, Episodic, or Procedural).
Subtly integrate relevant recalled information into your responses. Use tools to persist memory updates. Respond after tool confirmation.

As noted above, to ensure correct task execution, the techniques herein also introduce a runtime verification and adaptation mechanism that performs any or all of the following:
1. Continuous Monitoring: The system continuously monitors agent activities and workflow execution.
2. Real-Time Evaluation: the one or more evaluators 534 assess agent outputs and workflow progress in real-time.
3. Dynamic Adaptation: Based on evaluation results, agent orchestrator 522 can update agent selection and modify the workflow at runtime.
4. Human-in-the-Loop: The system may also rely on human oversight to validate and refine agent outputs when necessary.

The system also includes a dynamic agent registry management mechanism with a memory-enhanced registry agent:
1. ReAct Paradigm: ReAct agent 530 may follow the Reasoning and Acting (ReAct) paradigm, combining reasoning with action-taking in an iterative process.
2. Tri-Partite Memory System: a memory system powered by memory graph database 532 with any or all of the following features:
   Semantic Memory: Stores factual knowledge about agents, their capabilities, APIs, and relationships
   Episodic Memory: Records specific instances of agent interactions, performance, and outcomes
   Procedural Memory: Encodes learned patterns for registry management and decision-making procedures

Such a registry may also support dynamic updating:
1. Continuous Monitoring: The system continuously tracks agent activities, interactions, and performance metrics.
2. Change Detection: ReAct agent 530 may also analyze the monitored data to identify significant changes that warrant registry updates.
3. Context-Aware Capability Assessment: The system evaluates agent capabilities in different contexts, enabling more accurate agent selection for specific tasks.
4. Learning and Adaptation: The registry agent continuously learns from observations and outcomes, becoming more efficient and accurate over time.

By way of example, consider the following:
1. A user enters an initial query 504: “Given an instruction, write a code snippet, and provide feedback on its security, whether the code is performant and PEP 8 compliant. Incorporate such feedback in the code. Optimize for cost.”
2. Planner agent 502 decomposes this into atomic tasks:
   [Abridged] Write initial code snippet based on instruction
   Review code for security issues
   Review code for performance issues
   Review code for PEP 8 compliance
   Review code for dependency management
   Incorporate feedback and refine code
   Provide final code with unit tests and results
[ . . . ]
3. For each task, the system:
   Consults the agent directory 518, which the system dynamically maintains, to select the most appropriate agent
   Executes the task with the selected agent(s)
   Verifies the correctness of the output using specialized evaluators
   Feeds evaluation results back to the orchestrator, which automatically builds a workflow
4. ReAct agent 530 continuously updates agent directory 518 based on:
   Performance metrics from the one or more evaluators 534
   Contextual performance patterns (e.g., an agent performs well for security reviews but poorly for performance optimization)
   Changes in agent capabilities or availability
5. Agent orchestrator 522 adapts the workflow as needed based on verification results and updates to agent directory 518.

As would be appreciated, the proposed system has the following advantages:
1. Goal Optimization: the techniques herein optimize workflows based on specific business objectives, ensuring alignment with organizational priorities.
2. Human-Agent Collaboration: The system facilitates effective collaboration between humans and agents, creating a team-based approach to problem-solving that leverages both machine efficiency and human judgment.
3. Comprehensive Verification: By implementing multi-level verification (MAS/agents' level), the system significantly reduces the risk of errors and ensures that agents correctly perform their assigned tasks.
4. Dynamic Registry Updates: The system automatically discovers new agent capabilities and updates the agent directory, accordingly, ensuring that the most current information is always available for agent selection.
5. Flexibility: The system can handle a wide range of goals and adapt to changing requirements.
6. Scalability: The distributed architecture allows the system to scale to large numbers of agents and complex workflows.
7. Automation: Unlike existing systems that rely on predefined workflows or manual configuration, this invention automatically generates workflows based on high-level goals, adapting to the specific requirements of each task.
8. Efficiency: Automatic workflow generation and optimization dramatically reduces the time and resources required to achieve goals.
9. Reliability: Comprehensive monitoring, verification, and adaptation capabilities ensure that workflows are executed reliably.
10. Security: Built-in security features protect sensitive information and prevent unauthorized access.
11. Interoperability: Standardized protocols enable agents from different vendors and platforms to collaborate effectively.
12. Continuous Improvement: The system learns from each execution, continuously improving its performance over time.

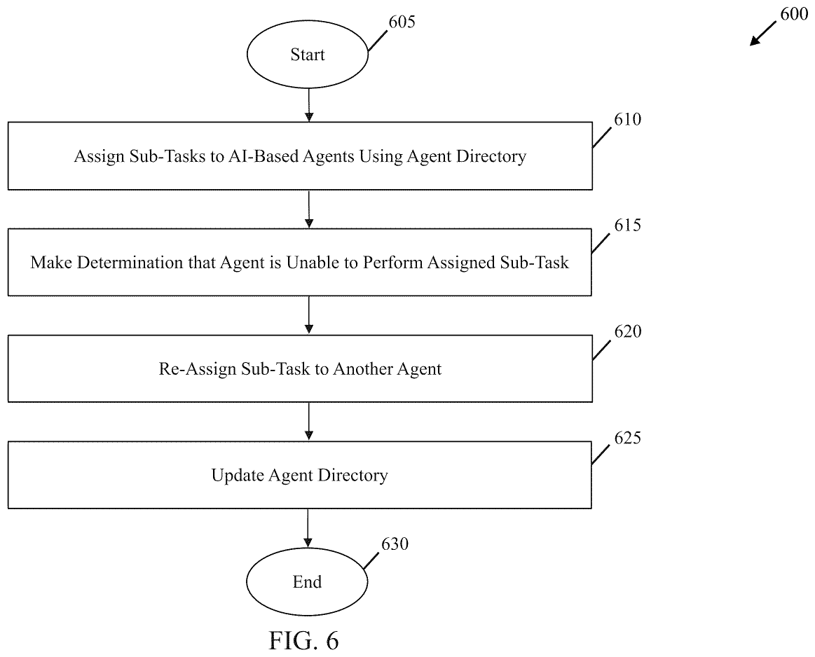

FIG. 6 illustrates an example simplified procedure for automatically generating workflows for AI agents, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, etc.) may assign sub-tasks to a plurality of artificial intelligence-based agents in a multi-agent system to complete a task, based on information indicative of their capabilities stored in an agent directory. In some implementations, the device may do so by using synthetic or runtime data to determine which agents should perform the sub-tasks. In one implementation, the device may also use Atom of Thought (AoT) reasoning to decompose the task into the sub-tasks. In a further implementation, the sub-tasks are based in part on feedback from a user interface.

At step 615, as detailed above, the device may make a determination that a particular agent from among the plurality of artificial intelligence-based agents is unable to perform its assigned sub-task based on telemetry data regarding performance of the sub-tasks by the plurality of artificial intelligence-based agents. In some implementations, a large language model (LLM)-as-a-judge model makes the determination. In some implementations, the telemetry data comprises a rubric associated with the sub-task assigned to the particular agent, a consistency measure associated with that sub-task, or an error detection rate associated with that sub-task. In a further implementation, the telemetry data comprises at least one performance metric for the multi-agent system. In various instances, the at least one performance metric for the multi-agent system comprises one or more of: a cross-component utilization rate, a workflow cohesion index, a component conflict rate, a component synergy score, or a downstream quality metric.

At step 620, the device may re-assign, based on the determination, a sub-task from the particular agent to another agent in the multi-agent system during completion of the task, as described in greater detail above. In some implementations, the device re-assigns the sub-task based in part on feedback from a user interface.

At step 625, as detailed above, the device may update the information in the agent directory to reflect the determination. In some implementations, the device may do so by accessing a memory graph database that comprises an episodic memory, a semantic memory, and a procedural memory that each stores information regarding the particular agent.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for automatic workflow generation with built-in verification mechanisms and dynamic registry management, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
assigning, by a device, sub-tasks to a plurality of artificial intelligence-based agents in a multi-agent system to complete a task, based on information indicative of their capabilities stored in an agent directory;
making, by the device, a determination that a particular agent from among the plurality of artificial intelligence-based agents is unable to perform its assigned sub-task based on telemetry data regarding performance of the sub-tasks by the plurality of artificial intelligence-based agents;
re-assigning, by the device and based on the determination, a sub-task from the particular agent to another agent in the multi-agent system during completion of the task; and
updating, by the device, the information in the agent directory to reflect the determination.

2. The method as in claim 1, wherein updating the information in the agent directory to reflect the determination comprises:
accessing a memory graph database that comprises an episodic memory, a semantic memory, and a procedural memory that each stores information regarding the particular agent.

3. The method as in claim 1, wherein assigning the sub-tasks to the plurality of artificial intelligence-based agents comprises:
using synthetic or runtime data to determine which agents should perform the sub-tasks.

4. The method as in claim 1, wherein a large language model (LLM)-as-a-judge model makes the determination.

5. The method as in claim 1, further comprising:
using Atom of Thought (AoT) reasoning to decompose the task into the sub-tasks.

6. The method as in claim 5, wherein the sub-tasks are based in part on feedback from a user interface.

7. The method as in claim 1, wherein the telemetry data comprises a rubric associated with the sub-task assigned to the particular agent, a consistency measure associated with that sub-task, or an error detection rate associated with that sub-task.

8. The method as in claim 1, wherein the telemetry data comprises at least one performance metric for the multi-agent system.

9. The method as in claim 8, wherein the at least one performance metric for the multi-agent system comprises one or more of: a cross-component utilization rate, a workflow cohesion index, a component conflict rate, a component synergy score, or a downstream quality metric.

10. The method as in claim 1, wherein the device re-assigns the sub-task based in part on feedback from a user interface.

11. An apparatus, comprising:
one or more network interfaces;
a processor coupled to the one or more network interfaces and configured to execute one or more processes; and
a memory configured to store a process that is executable by the processor, the process when executed configured to:
assign sub-tasks to a plurality of artificial intelligence-based agents in a multi-agent system to complete a task, based on information indicative of their capabilities stored in an agent directory;
make a determination that a particular agent from among the plurality of artificial intelligence-based agents is unable to perform its assigned sub-task based on telemetry data regarding performance of the sub-tasks by the plurality of artificial intelligence-based agents;
re-assign, based on the determination, a sub-task from the particular agent to another agent in the multi-agent system during completion of the task; and
update the information in the agent directory to reflect the determination.

12. The apparatus as in claim 11, wherein the apparatus updates the information in the agent directory to reflect the determination by:
accessing a memory graph database that comprises an episodic memory, a semantic memory, and a procedural memory that each stores information regarding the particular agent.

13. The apparatus as in claim 11, wherein the apparatus assigns the sub-tasks to the plurality of artificial intelligence-based agents by:
using synthetic or runtime data to determine which agents should perform the sub-tasks.

14. The apparatus as in claim 11, wherein a large language model (LLM)-as-a-judge model makes the determination.

15. The apparatus as in claim 11, wherein the process when executed is further configured to:
use Atom of Thought (AT) reasoning to decompose the task into the sub-tasks.

16. The apparatus as in claim 15, wherein the sub-tasks are based in part on feedback from a user interface.

17. The apparatus as in claim 11, wherein the telemetry data comprises a rubric associated with the sub-task assigned to the particular agent, a consistency measure associated with that sub-task, or an error detection rate associated with that sub-task.

18. The apparatus as in claim 11, wherein the telemetry data comprises at least one performance metric for the multi-agent system.

19. The apparatus as in claim 18, wherein the at least one performance metric for the multi-agent system comprises one or more of: a cross-component utilization rate, a workflow cohesion index, a component conflict rate, a component synergy score, or a downstream quality metric.

20. A tangible, non-transitory, computer-readable medium storing program instructions that cause a device to execute a process comprising:
assigning, by the device, sub-tasks to a plurality of artificial intelligence-based agents in a multi-agent system to complete a task, based on information indicative of their capabilities stored in an agent directory;
making, by the device, a determination that a particular agent from among the plurality of artificial intelligence-based agents is unable to perform its assigned sub-task based on telemetry data regarding performance of the sub-tasks by the plurality of artificial intelligence-based agents;
re-assigning, by the device and based on the determination, a sub-task from the particular agent to another agent in the multi-agent system during completion of the task; and
updating, by the device, the information in the agent directory to reflect the determination.
